(19) United States
(12) Patent Application Publication
(10) Pub. No.: US 2012/0066959 A1
(43) Pub. Date: Mar. 22, 2012

(54) DOOR ASSEMBLY FOR A TOBACCO STORAGE FACILTY, AND ASSOCIATED APPARATUS AND METHOD

(75) Inventors: Stephen Thomas Matthews, Clemmons, NC (US); Tim Lee Flinchum, Danbury, NC (US); Vernon Benno Schmidt, (US)

(73) Assignee: R.J. Reynolds Tobacco Company

(21) Appl. No.: 12/883,605

(22) Filed: Sep. 16, 2010

(51) Int. Cl. A01M 13/00; A01M 1/20; E06B 9/52

(52) U.S. Cl. 43/125; 52/673; 52/517; 49/58

(57) ABSTRACT

An apparatus and associated method are provided for protecting a tobacco storage facility used to contain tobacco material. The tobacco storage facility includes a tobacco enclosure defining at least one enclosure opening for providing access to the tobacco enclosure. A door assembly is operably engaged with the tobacco enclosure about the at least one enclosure opening. The door assembly includes a screen arrangement having a mesh sized to limit tobacco pests from passing therethrough. The door assembly is configured such that the screen arrangement is capable of moving between a closed position covering the tobacco enclosure and an open position allowing access to the tobacco enclosure. A method of monitoring pests in a tobacco enclosure is provided. The interior of the tobacco enclosure is monitored for pests using a monitoring system. At least a portion of the interior is fumigated if the number of detected pests meets or otherwise exceeds a predetermined pest threshold.

### FIELD OF THE DISCLOSURE

The present disclosure relates to the storage of tobacco material, and, more particularly, to pest protection of tobacco material stored in a tobacco storage facility.

### BACKGROUND OF THE DISCLOSURE

Each year, nearly seven million tons of tobacco are produced worldwide. Tobacco is typically sowed in fields and then harvested annually. After harvesting, the tobacco is typically stored to be subjected to the stages of drying, curing, fermenting, and/or aging to produce a tobacco suitable for being processed into a form for smoking or chewing.

Like other cultivated plants, tobacco and tobacco products are subject to numerous pests. One significant concern is the presence of pests in the enclosures housing tobacco to be dried, cured, fermented, and/or aged. For example, cigarette beetles and other types of beetles (e.g., vegetable weevils and whitefringed beetles) are known to feed on dried tobacco of all kinds. The insect larvae is often primarily responsible for the damage caused to tobacco, although adults may also feed on the tobacco. Tobacco moths are another pest that may pose a threat to stored tobacco. Damage to dried tobacco caused by these insects may cause millions of dollars in loss of tobacco.

To address the concern of pests, one common strategy is to store the tobacco in enclosures that are periodically fumigated to reduce or eliminate target pest populations. However, controlling pests via such periodic fumigations has a number of drawbacks. Fumigation is an intensive process. Fumigation may be conducted on enclosures that are not currently in need of fumigation, and thus, in some cases, may be a waste of resources. In other enclosures, it may be beneficial to conduct fumigations more regularly due to bigger pest problems.

Thus, it would be beneficial to provide a system by which pests could be more effectively excluded from tobacco enclosures, to reduce the frequency with which fumigation needs to be conducted. Further, it would be beneficial to provide a monitoring system to trigger fumigation when it is needed, rather than to rely on periodic fumigations to control the pest level in all tobacco enclosures.

### SUMMARY OF THE DISCLOSURE

In some aspects, the present disclosure relates to a door assembly that may be designed so as to effectively cover an entrance to a tobacco enclosure.

In some aspects, the present disclosure relates to an enclosure for the containment of tobacco or tobacco products. In some aspects, one or more entrances to the enclosure comprises a door assembly having a screen arrangement with a mesh size suitable for limiting pests from passing therethrough. For example, in some aspects, the mesh size is suitable for excluding cigarette beetles from passing therethrough. In some aspects, the door assembly has a mesh size of less than about 2 mm. In some aspects, the door assembly is a rollup screen door. In some aspects, the screen arrangement of the door assembly comprises an insecticide.

In some aspects, the present disclosure relates to a method for protecting tobacco or tobacco products from pests (e.g., cigarette beetles, tobacco moths, or both). In some aspects, the method comprises containing tobacco or tobacco products within a tobacco enclosure wherein one or more entrances to the enclosure comprises a door assembly having a screen arrangement with a mesh size suitable for keeping pests from passing through. For example, in some embodiments, the screen arrangement of the door assembly has a mesh size suitable for keeping cigarette beetles, tobacco moths, or both from passing therethrough.

In some aspects, the present disclosure relates to a method of monitoring pests in an enclosure for the containment of tobacco or tobacco products. In some aspects, the method comprises providing a door assembly operably engaged with a tobacco enclosure about an enclosure opening thereof, the door assembly having a screen arrangement having a mesh sized to limit tobacco pests from passing therethrough, the door assembly being configured such that the screen arrangement is capable of moving between a closed position covering the tobacco enclosure and an open position allowing access to the tobacco enclosure; monitoring an interior of the tobacco enclosure for the presence of tobacco pests using a monitoring system having a collection system configured to attract and trap tobacco pests; comparing the number of trapped pests to a predetermined pest threshold criteria to determine if the predetermined pest threshold criteria has been met; and fumigating at least a portion of the tobacco enclosure when the monitoring system indicates the predetermined pest threshold criteria has been met.

### BRIEF DESCRIPTION OF THE DRAWINGS

FIG. 1 is a perspective view of a tobacco storage facility having door assembly in accordance with one aspect of the present disclosure, with the door assembly being in a closed position;

FIG. 2 is a perspective view of the tobacco storage facility of FIG. 1, with the door assembly in an open position;

FIG. 3 is a perspective view of the tobacco storage facility of FIG. 1, with the door assembly in an intermediate position between the open and closed positions; and

FIG. 4 is a partial view of the door assembly shown in FIG. 1.

### DETAILED DESCRIPTION OF THE INVENTION

The present disclosure now will be described more fully hereinafter. The aspects of the present disclosure may be embodied in many different forms and should not be construed as limited to the aspects set forth herein; rather, these aspects are provided so that this disclosure will satisfy applicable legal requirements. Like numbers refer to like elements throughout. Many modifications and other aspects of the disclosure set forth herein will come to mind to one skilled in the art to which these aspects pertain having the benefit of the teachings presented in the foregoing descriptions and the associated drawings. Therefore, it is to be understood that the present disclosure is not to be limited to the specific aspects disclosed and that modifications and other aspects are intended to be included within the scope of the appended claims. Although specific terms are employed herein, they are used in a generic and descriptive sense only and not for purposes of limitation.

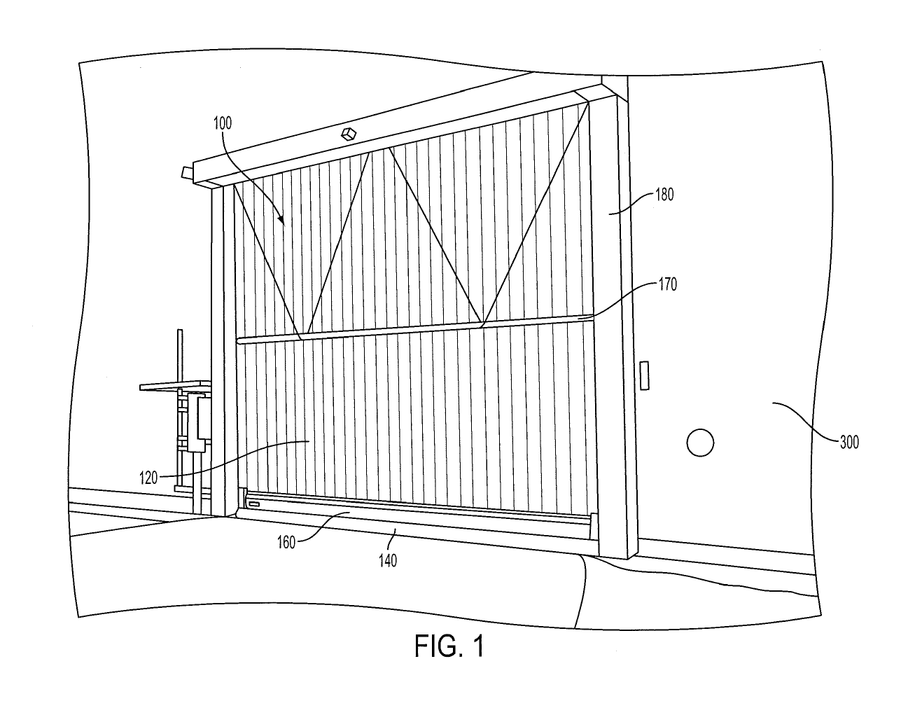

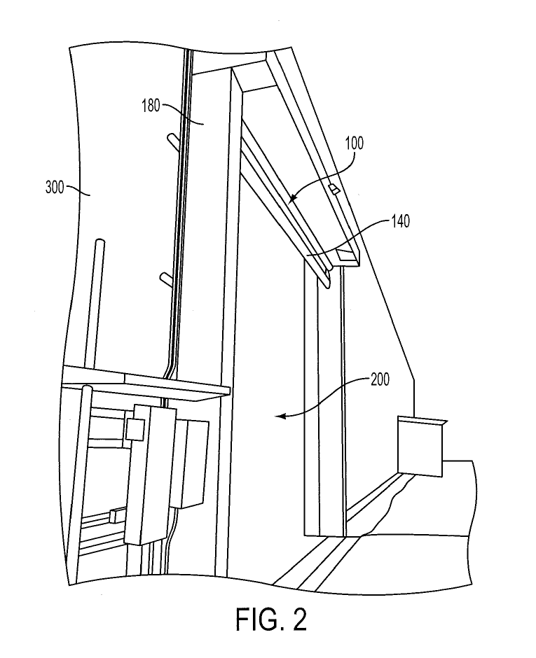

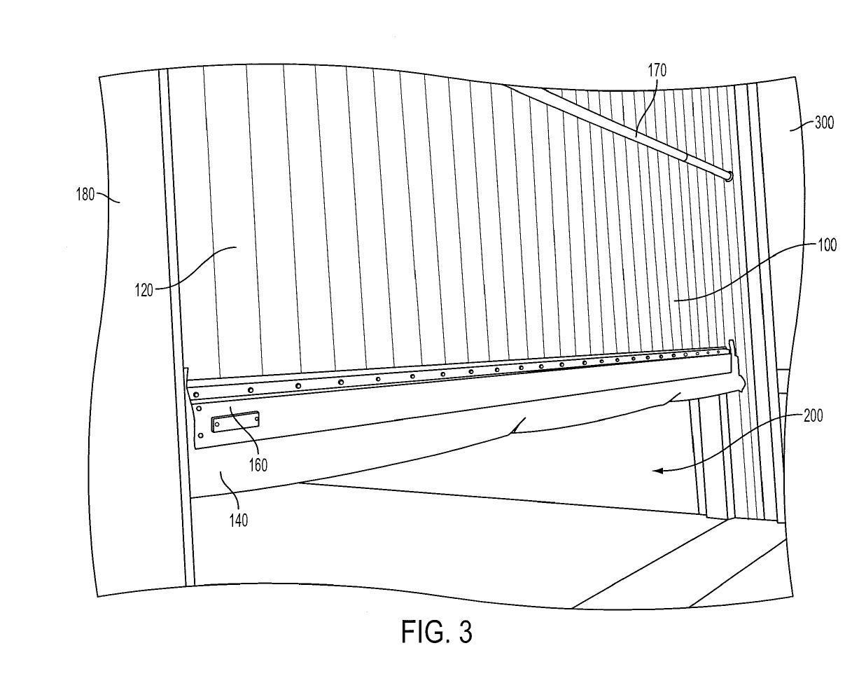

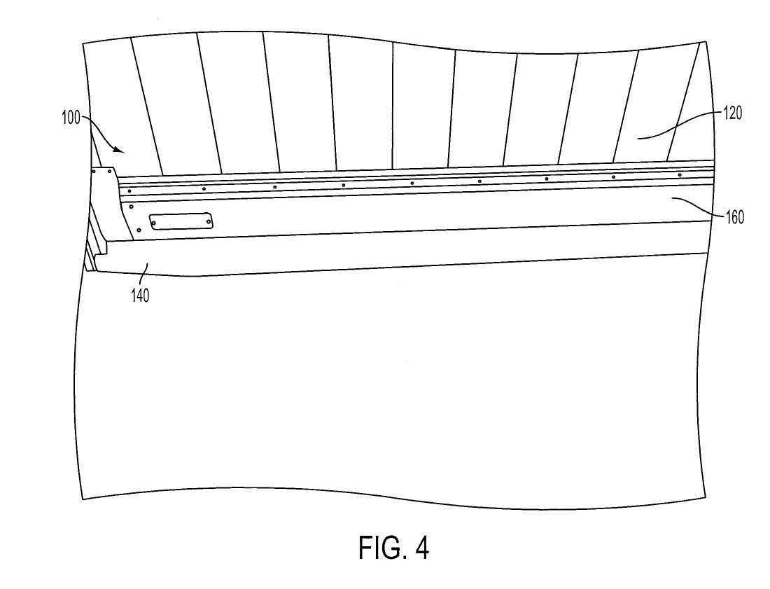

In one aspect of the present disclosure is provided a door assembly 100 that may be adapted to cover an entrance 200 (FIGS. 2 and 3) to a tobacco storage facility. As shown in FIGS. 1-4, the tobacco storage facility may comprise a tobacco enclosure 300 which may be any structure in which tobacco, tobacco material, or tobacco products can be stored.

The tobacco, tobacco material, or tobacco products stored in the tobacco storage facility may incorporate some form of a plant of the Nicotiana species, and in most instances, the tobacco, tobacco material, or tobacco products may incorporate some form of tobacco. The selection of the Nicotiana species can vary; and in particular, the selection of the types of tobacco or tobaccos may vary. Tobaccos that can be employed include flue-cured or Virginia (e.g., K326), burley, sun-cured (e.g., Indian Kurnool and Oriental tobaccos, including Katerini, Prelip, Komotini, Xanthi and Yambol tobaccos), Maryland, dark, dark-fired, dark air cured (e.g., Passanda, Cubano, Jatin and Bezuki tobaccos), light air cured (e.g., North Wisconsin and Galpao tobaccos), Indian air cured, Red Russian and Rustica tobaccos, as well as various other rare or specialty tobaccos. Descriptions of various types of tobaccos, growing practices and harvesting practices are set forth in Tobacco Production, Chemistry and Technology, Davis et al. (Eds.) (1999), which is incorporated herein by reference. Various representative other types of plants from the Nicotiana species are set forth in Goodspeed, The Genus Nicotiana, (Chonica Botanica) (1954); U.S. Pat. No. 4,660,577 to Sensabaugh, Jr. et al.; U.S. Pat. No. 5,387,416 to White et al. and U.S. Pat. No. 7,025,066 to Lawson et al.; US Patent Appl. Pub. Nos. 2006/0037623 to Lawrence, Jr. and 2008/0245377 to Marshall et al.; each of which is incorporated herein by reference. Exemplary Nicotiana species include N. tabacum, N. rustica, N. alata, N. arentsii, N. excelsior, N. forgetiana, N. glauca, N. glutinosa, N. gossei, N. kawakamii, N. knightiana, N. langsdorffi, N. otophora, N. setchelli, N. sylvestris, N. tomentosa, N. tomentosiformis, N. undulata, N. x sanderae, N. africana, N. amplexicaulis, N. benavidesii, N. bonariensis, N. debneyi, N. longiflora, N. maritina, N. megalosiphon, N. occidentalis, N. paniculata, N. plumbaginifolia, N. raimondii, N. rosulata, N. simulans, N. stocktonii, N. suaveolens, N. umbratica, N. velutina, N. wigandioides, N. acaulis, N. acuminata, N. attenuata, N. benthamiana, N. cavicola, N. clevelandii, N. cordifolia, N. corymbosa, N. fragrans, N. goodspeedii, N. linearis, N. miersii, N. nudicaulis, N. obtusifolia, N. occidentalis subsp. Hersperis, N. pauciflora, N. petunioides, N. quadrivalvis, N. repanda, N. rotundifolia, N. solanifolia, and N. spegazzinii.

Nicotiana species can be derived using genetic-modification or crossbreeding techniques (e.g., tobacco plants can be genetically engineered or crossbred to increase or decrease production of components, characteristics or attributes). See, for example, the types of genetic modifications of plants set forth in U.S. Pat. No. 5,539,093 to Fitzmaurice et al.; U.S. Pat. No. 5,668,295 to Wahab et al.; U.S. Pat. No. 5,705,624 to Fitzmaurice et al.; U.S. Pat. No. 5,844,119 to Weigl; U.S. Pat. No. 6,730,832 to Dominguez et al.; U.S. Pat. No. 7,173,170 to Liu et al.; U.S. Pat. No. 7,208,659 to Colliver et al. and U.S. Pat. No. 7,230,160 to Benning et al.; US Patent Appl. Pub. No. 2006/0236434 to Conkling et al.; and PCT WO 2008/103935 to Nielsen et al.

For the preparation of smokeless and smokable tobacco products, it is typical for harvested plant of the Nicotiana species to be subjected to a curing process. Descriptions of various types of curing processes for various types of tobaccos are set forth in Tobacco Production, Chemistry and Technology, Davis et al. (Eds.) (1999). Exemplary techniques and conditions for curing flue-cured tobacco are set forth in Nestor et al., Beitrage Tabakforsch. Int., 20, 467-475 (2003) and U.S. Pat. No. 6,895,974 to Peele, which are incorporated herein by reference. Representative techniques and conditions for air curing tobacco are set forth in U.S. Pat. No. 7,650,892 to Groves et al.; Roton et al., Beitrage Tabakforsch. Int., 21, 305-320 (2005) and Staaf et al., Beitrage Tabakforsch. Int., 21, 321-330 (2005), which are incorporated herein by reference. Certain types of tobaccos can be subjected to alternative types of curing processes, such as fire curing or sun curing. Preferably, harvested tobaccos that are cured are then aged. As such, tobaccos used for the preparation of tobacco compositions or products most preferably incorporate components of tobaccos that have been cured and aged.

At least a portion of the plant of the Nicotiana species (e.g., at least a portion of the tobacco portion) can be employed in an immature form. That is, the plant, or at least one portion of that plant, can be harvested before reaching a stage normally regarded as ripe or mature. As such, for example, tobacco can be harvested when the tobacco plant is at the point of a sprout, is commencing leaf formation, is commencing flowering, or the like.

At least a portion of the plant of the Nicotiana species (e.g., at least a portion of the tobacco portion) can be employed in a mature form. That is, the plant, or at least one portion of that plant, can be harvested when that plant (or plant portion) reaches a point that is traditionally viewed as being ripe, over-ripe or mature. As such, for example, through the use of tobacco harvesting techniques conventionally employed by farmers, Oriental tobacco plants can be harvested, burley tobacco plants can be harvested, or Virginia tobacco leaves can be harvested or primed by stalk position.

After harvest, the plant of the Nicotiana species, or portion thereof, can be used in a green form (e.g., tobacco can be used without being subjected to any curing process). For example, tobacco in green form can be frozen, subjected to irradiation, yellowed, dried, cooked (e.g., roasted, fried or boiled), or otherwise subjected to storage or treatment for later use. Such tobacco also can be subjected to aging conditions.

In some instances, the tobacco enclosure 300 may have a roof, sidewalls, and a floor, wherein the roof, sidewalls, and floor define an enclosure. In some aspects, the enclosure may be a tobacco curing/storage shed or barn. The tobacco enclosure 300 may have one or more entrances. The door assembly 100 may be of any size and shape such that it is effective to cover one of the entrances 200.

According to some aspects, the door assembly 100 may include a screen arrangement 120 being formed at least partially of any material that can be prepared as a screen with a predetermined mesh size. The material preferably has some degree of flexibility. In certain aspects, the material is a textile-based material, a plastic-based material, a metal-based material, or a fiberglass-based material. The material may comprise natural or synthetic yarns or fibers and may be a woven or non-woven fabric. For example, the material may comprise synthetic yarns or fibers such as polyesters, polyamides, nylons, or polyolefins or natural yarns or fibers such as cotton, wool, silk, jute, linen, ramie, or hemp.

The material of the screen arrangement 120 may further comprise one or more additional components. Such additional components may be incorporated within the material comprising the mesh or may be coated on the exterior of the mesh. In some aspects, the screen arrangement 120 may further comprise one or more coatings on one or both surfaces of the screen. For example, in one aspect, the screen arrangement 120 may further comprise a vinyl coating. In some embodiments, the material may be treated to provide one or more benefits such as, for example, mildew/mold resistance, flame retardance, and/or UV resistance. In certain aspects, the screen arrangement 120 may further comprise or otherwise be treated with an insecticide. For example, in some embodiments, an insecticide may be incorporated within the fibers of the mesh themselves, or the insecticide may be applied to the surface of the mesh. See, for example, U.S. Patent Application Publication 2009/0246242 to Leininger et al., which is incorporated herein by reference.

The size and shape of the mesh may vary. In some instances, the size and shape of the mesh is uniform. In certain aspects, the screen arrangement 120 may have any size mesh suitable for preventing one or more known pests to pass through. For example, vegetable weevils are about 6.4 mm long, whitefringed beetles are about 11 mm long, and cigarette beetles are about 2-4 mm long. Tobacco moths are typically from about 6 to about 9 mm long. Accordingly, in certain aspects, suitable dimensions of the mesh are in the range of less than about 5 mm, less than about 2.5 mm, less than about 2 mm, or less than about 1.5 mm. Similarly, the shape of the mesh may be selected based on the dimensions of the pest(s) to be prevented from passing therethrough. In some instances, the screen arrangement 120 may be provided in such a manner so as to substantially cover an entire opening defined by the tobacco enclosure 300. For example, in some instances, the screen arrangement 120 may be about 5 meters to about 10 meters in length and about 5 meters to about 10 meters in width.

The door assembly 100 may further include an apron 140 disposed at or proximate to a bottom portion 160 thereof. The apron 140 may contact the floor or ground surface when the door assembly 100 is in a closed position such that pests cannot enter the tobacco enclosure 300 underneath the bottom portion 160 of the door assembly 100. In this regard, the apron 140 may compress against the floor or ground surface to form a seal along the length of the entrance 200 of the tobacco enclosure 300. The apron 140 may be constructed from a flexible material capable of compression such as, for example, a nylon material or other suitable sealant, flexible or compression material. Typically, the apron 140 may extend along the entire width of the screen arrangement 120 or otherwise substantially spanning the width of an opening of the tobacco enclosure 300. For example, in some instances, the apron 140 may be about 5 meters to about 10 meters in length so as to correspond to the width of the screen arrangement 120 for preventing or otherwise limiting access into the tobacco enclosure 300 below the screen arrangement 120 when in the closed position.

In some instances, the door assembly 100 may include a support structure such as, for example, a support rod 170 for providing support and rigidity to the door assembly 100 during opening and closing thereof.

The door assembly 100 may be attached to a door opening of the tobacco enclosure 300 via a door frame 180 such as, for example, a metal frame, wooden frame, and/or composite frame. The door assembly 100/door frame 180 may be joined to the door opening via any means recognized as useful for such purposes. For example, the door assembly 100 may be attached with adhesives, mechanical fasteners (e.g., staples or tacks), or may be attached by binding the screen arrangement 120 into recesses in the door frame 180. In some instances, the door assembly 100 may be attached in such a way so as to be readily opened and closed to allow workers to enter and exit the tobacco enclosure 300 as necessary. Thus, in some aspects, the door assembly 100 may be retractable. Further, the door assembly 100 may be automatically retractable wherein sensors detect the presence/absence of, for example, a vehicle such that the door assembly 100 automatically opens when the vehicle is proximate to the door assembly 100 and then closes once the vehicle has completely entered or exited the tobacco enclosure 300. For example, sensors may be positioned underneath a paved surface for detecting the force of a vehicle, or positioned on or near the tobacco storage facility to detect motion.

The door assembly 100 may be opened and closed may be any mechanisms that provide for such. For example, in some aspects, the door assembly 100 may be a roller screen door, a hinged screen door, or a screen door that opens and closes via a folding mechanism. In certain aspects, the door assembly 100 may be tensioned so as to enable the door assembly 100 to maintain a tight seal against the ground or floor surface. In certain aspects, the door assembly 100 may be opened and closed via a manual system or via a motorized system. In some aspects, the door assembly 100 may be sealed within an opening to the tobacco enclosure 300 along one, two, three, or all four edges of the door assembly 100.

As noted, in some aspects, the door assembly 100 may be a roller screen door. In such aspects, the roller screen door may be attached to the enclosure opening such that the door assembly 100 may be selectively raised and lowered to open and close the opening to the enclosure. In certain aspects, the door assembly 100 may be designed to fit within an enclosure opening of the tobacco enclosure 300 and may be attached to the vertical sides of the enclosure opening by being positioned within tracks or channels attached to the vertical sides of the inner frame of the enclosure opening. In some aspects, the door assembly 100 may be affixed to a spring-biased roll upon which the door assembly 100 is initially wound, and which can be unwound from the roll against the tension of the spring bias. In other aspects, the door assembly 100 may be affixed to a roll upon which the door assembly 100/screen arrangement 120 is initially wound, which operates via a motor. In other aspects, the door assembly 100 may be affixed to a roll that can be turned via a chain hoist system. In certain aspects, when the door assembly 100 is fully lowered, it extends at least to the lower horizontal threshold of the inner frame of the enclosure opening such that there is no gap between the bottom edge of the door assembly 100 (the apron 140 when provided) and the threshold. In some aspects, the bottom portion 160 of the door assembly 100 may be configured so as to attach to the bottom threshold of the enclosure opening. In some aspects, the bottom portion 160 (or the apron 140) of the door assembly 100 may be weighted or otherwise adapted to provide a tight seal in combination with the bottom threshold of the enclosure opening.

According to some aspects, the door assembly 100 may be a roller screen door that is affixed to a roll in a vertical orientation such that the roll is attached to a vertical side of the enclosure opening. In such aspects, the rolls may be spring-biased rolls or may operate via a motorized system. The door assembly 100 may be unwound from the roll and attached to the horizontal sides of the enclosure opening by being positioned within tracks or channels attached to the horizontal sides of the inner frame of the enclosure opening. In certain aspects, when the roller screen door is in the closed position, it extends to the other vertical side of the enclosure opening such that there is no gap between the edge of the door assembly 100 and the vertical side of the enclosure opening. In other instances, the door assembly 100 may comprise two sections, wherein each section is attached to one of the vertical sides of the enclosure opening, for example, on two rolls. The two screen sections may be extended horizontally and are sized such that they meet and can be attached to form a continuous covering to completely cover the enclosure opening.

Other aspects of methods by which a door assembly 100 may be positioned so as to cover the entrance 200 to the enclosure are also envisioned. For example, the door assembly 100 may be a sliding curtain that is opened and closed via a trolley mechanism. One of skill in the art would be aware of other mechanisms and door arrangements that would be relevant to the present application.

Commercial producers of door assemblies 100 that may be modified according to the present disclosure include, but are not limited to, Industrial Curtains (e.g., G2 doors), Rytec (e.g., Bantam® doors, Fast-Seal® doors, Predadoor® doors, TMI, LLC (e.g., ScreenPro® products), Gateway Industrial Products (e.g., Bug Barrier products), Pioneer Industrial Doors (e.g., NoPest™ products), RiteHite (e.g., BugShield screen doors), Horman Flexon LLC (e.g., Screen Master® doors) and Rasco Industries, Inc. (e.g., BugBlocker doors).

In some aspects, the use of a screen door assembly 100 having the screen arrangement 120 as described herein may maintain relatively low pest counts within the enclosure 300. According to some aspects, when the door assembly 100 is fully closed, it may be effective at limiting one or more types of pests from passing through the enclosure opening.

In another aspect of the present disclosure is provided a method for protecting tobacco and/or tobacco products stored within the enclosure 300. In some aspects, the method includes placing the tobacco in an enclosure 300 having at least one door assembly 100 having a screen arrangement 120 as described herein. In some instances, the door assembly 100 may be maintained in a closed position except during short periods of time when access to the enclosure 300 is required.

In certain aspects, the method of protecting tobacco and/or tobacco products further comprises using a monitoring system to monitor the presence of one or more pests. The monitoring system may be any type recognized as useful for detecting one or more tobacco pests. In some aspects, one or more monitoring systems may be set up within the tobacco enclosure 300. In some aspects, the monitoring system may comprise a collection system. In some instances, the collection system may include a lure in combination with a trap that can be checked to monitor the presence of a particular tobacco pest. The lure and trap may operate, for example, by using one or more specific pheromones and/or one or more food attractants. In some aspects, the monitoring system is a trap for cigarette beetles and/or tobacco moths. In some aspects, traps for cigarette beetles include, but are not limited to, serricornin (4,6-dimethyl-7-hydroxy-nonan-3-one)-based traps, which use the female cigarette beetle sex pheromone to attract and then trap male beetles. In some aspects, commercially available traps are used. For example, certain cigarette beetle traps include Sanitrap®, X-Lure® Cigarette Beetle Pheremone Trap, Propest Pheronet® trap, New Serrico® trap, Cigarette Beetle NoSurvivor® trap, PC®Floor Trap, Lasiotrap®, Storgard Dome™ trap, Thinline™ trap, or MicroDot™ trap. Some traps also target female cigarette beetles (e.g., Storgard® CB Combo™). Traps for tobacco moths include, but are not limited to, Gachon® trap, X-Lure® Indian Meal Moth Pheremone Trap, Propest Pheronet® trap, Easiset Delta® trap, Allure® Insect trap, Storgard® trap, Pherocon® trap, Thinline™ trap, and MicroDot™ trap. In certain aspects, the trap may be designed to trap more than one type of pest. For example, in some aspects, a Thinline™ trap is used, which targets both beetles and moths.

The traps may be monitored at regular intervals to count the number of pests trapped therein. For example, the traps may be checked once per day, once every few days, or once per week. Where the traps are located within an enclosure having entrances sealed with screen door assemblies as described herein, the traps may be used to ensure that the enclosure is maintained at a pest level that is sufficiently low.

In some instances, when the trap indicates a predetermined number of pests or otherwise exceeds a predetermined pest threshold criteria, the tobacco enclosure may be fumigated. In some instances, the predetermined pest threshold criteria may signify a threshold number of trapped pests that must be met or, in other instances, may signify a threshold number of trapped pests that must be exceeded. Further, the predetermined number of pests may be, for example, based on monitoring of an increasing number of trapped pests occurring over a period of time (i.e., a durational component). For example, a trap having five or more pests each week over a three week period may constitute the need for fumigation. In some instances, the predetermined pest threshold may be based on regulatory demands in regard to agricultural stored products such as tobacco leaf material. In any event, the quantity of monitored trapped pests is compared to the predetermined pest threshold criteria to determine if the predetermined pest threshold criteria is met or otherwise exceeded. In such instances that the predetermined pest threshold criteria is met or otherwise exceeded, a fumigation procedure may be implemented to address the pest infestation.

The fumigation may be done in any way typically performed. In some instances, the fumigation requires the enclosure to be completely sealed and a fumigant is released into the space. For example, an air-tight covering (e.g., plastic sheeting) may be securely positioned to cover the opening of the enclosure (in some instances, covering the door assembly 100 as well if the screen arrangement 120 is in the closed position) such that the fumigant is contained within the tobacco enclosure. The space is held this way for a period of time so that the fumigant may act on the pests. The space then is ventilated, allowing the fumigant to be released from the space. In this regard, the air-tight covering may be removed from the opening to ventilate the space. However, to prevent further infestation into the tobacco enclosure, the screen arrangement 120 advantageously may be positioned to cover the opening of the tobacco enclosure, which simultaneously allows for ventilation of the space as well as for blocking of tobacco pests from entering the tobacco enclosure. That is, through use of the door assembly 100, ventilation of the space can occur while also limiting access to the tobacco enclosure by any tobacco pests. Any substance that is effective against one or more tobacco pests known to exist within the enclosure may be used for the fumigation. For example, the enclosure may be fumigated using phosphine or phosphine containing products such as, for example, FUMI-STRIP available from Degesch America, Inc.

According to one exemplary aspect of the present disclosure, the following fumigation procedure may be implemented after a predetermined number of pests have been collected by the monitoring system. The atmospheric temperature and the temperature at the center of the tobacco material may be measured just prior to fumigation. The air temperature may be, for example, at least between about 5° C. to about 10° C., and may be typically about 7° C. The commodity temperature may be, for example, above between about 10° C. to about 20° C., and may typically be about 16° C. Advantageously, the tobacco material may be typically placed on a clean, even, good quality floor with no gullies, drains, cracks or expansion joints. Monitoring lines for gas measurements may be established in the tobacco material (e.g., insert probe into the center of one portion of tobacco material) and airspace in the tobacco enclosure.

Typically, the area may be fumigated using magnesium phosphide. In some instances, the length of the fumigation may vary depending on temperature and phosphine penetration into the tobacco material. For example, if the tobacco material temperature is greater than about 20° C., the phosphine concentration in the center of the tobacco material may be at least about 150 ppm to about 250 ppm for at least about 90 to about 100 consecutive hours. If the tobacco material temperature is between about 15° C. and about 20° C., the phosphine concentration in the center of the tobacco material may be at least about 250 ppm to about 350 ppm for at least about 140 to about 150 consecutive hours. The duration of fumigation, enclosure temperature, etc. may be varied according to the enclosure type or size, the extent of infestation, or other factors considered for a sufficient fumigation procedure.

The phosphine levels are typically monitored at least three times during the fumigation using Dräger tubes or other industry approved monitoring devices connected to the monitoring lines. The timing of the readings and the number of readings may vary. For fumigations above about 20° C., the first reading may be taken, for example, between about 10 and 30 hours after the fumigant has been released under a covering (e.g., a tarpaulin), the second, for example, at about 70 to about 100 hours into the fumigation, and the third, for example, at about 110 to about 130 hours into the fumigation. For fumigations between about 15° C. and about 20° C., the first reading may be taken, for example, between about 10 and 30 hours after the fumigant has been released under the tarpaulin, the second, for example, between about 70 and 150 hours into the fumigation, and the third, for example, at about 160 to 170 hours into the fumigation. Additional readings may be taken to ensure that the phosphine concentrations stay above a minimum standard. If at any time the phosphine concentrations do not meet minimum requirements or if the rate of loss is such that the phosphine concentration will drop below the minimum standard, additional fumigant may be added to maintain levels above the minimum standard.

According to some aspects, the monitoring method disclosed herein may be capable of maintaining the level of pests within an enclosure at a low level. Accordingly, fumigation may be conducted less frequently than in the absence of such a monitoring system.

That which is claimed:

1. A tobacco storage facility for the containment of tobacco material, the facility comprising:
a tobacco enclosure defining at least one enclosure opening for providing access to the tobacco enclosure; and
a door assembly operably engaged with the tobacco enclosure about the at least one enclosure opening, the door assembly having a screen arrangement having a mesh sized to limit tobacco pests from passing therethrough, the door assembly being configured such that the screen arrangement is capable of moving between a closed position covering the tobacco enclosure and an open position allowing access to the tobacco enclosure.

2. The tobacco storage facility according to claim 1, wherein the screen arrangement has a mesh size of less than about 2 mm.

3. The tobacco storage facility according to claim 1, wherein the screen arrangement of the door assembly is configured to be retractable.

4. The tobacco storage facility according to claim 1, wherein the screen arrangement of the door assembly is treated with an insecticide.

5. The tobacco storage facility according to claim 1, wherein the door assembly further comprises an apron disposed about a bottom portion of the screen arrangement and configured to interact with a floor surface to seal the enclosure opening.

6. The tobacco storage facility according to claim 5, wherein the apron comprises a compressible material.

7. The tobacco storage facility according to claim 1, further comprising a monitoring system for detecting pests within the tobacco enclosure.

8. A method of monitoring pests in an enclosure for the containment of tobacco or tobacco products, comprising:
providing a door assembly operably engaged with a tobacco enclosure about an enclosure opening thereof, the door assembly having a screen arrangement having a mesh sized to limit tobacco pests from passing therethrough, the door assembly being configured such that the screen arrangement is capable of moving between a closed position covering the tobacco enclosure and an open position allowing access to the tobacco enclosure;
monitoring an interior of the tobacco enclosure for the presence of tobacco pests using a monitoring system having a collection system configured to attract and trap tobacco pests;
comparing the number of trapped pests to a predetermined pest threshold criteria to determine if the predetermined pest threshold criteria has been met; and
fumigating at least a portion of the tobacco enclosure when the monitoring system indicates the predetermined pest threshold criteria has been met.

9. The method according to claim 8, wherein the screen arrangement has a mesh size of less than about 2 mm.

10. The method according to claim 8, wherein the screen arrangement is treated with an insecticide.

11. The method according to claim 8, wherein the predetermined pest threshold criteria includes a durational component.

12. The method according to claim 8, wherein fumigating the tobacco enclosure comprises fumigating the tobacco enclosure with a phosphine concentration for at least about 90 to about 100 consecutive hours and at a temperature within the tobacco enclosure of greater than about 20° C.

13. The method according to claim 8, wherein fumigating the tobacco enclosure comprises fumigating the tobacco enclosure with a phosphine concentration for at least about 140 to about 150 consecutive hours and at a temperature within the tobacco enclosure of between about 15° C. and about 20° C.
